(19) United States
(12) Patent Application Publication
(10) Pub. No.: US 2005/0037632 A1
(43) Pub. Date: Feb. 17, 2005

(54) Lighted trailer wiring adapter

(76) Inventor: David H. Ihde, Osage City, KS (US)

Correspondence Address: Hovey Williams LLP, Suite 400, 2405 Grand Blvd., Kansas City, MO, 64108, US

(21) Appl. No.: 10/641,464

(22) Filed: Aug. 14, 2003

(51) Int. Cl. H01R 33/00

(52) U.S. Cl. 439/35

(57) ABSTRACT

A lighted wiring adapter (10) for connecting a towed vehicle (12) to a towing vehicle (14) and displaying a status of the vehicles' wiring. The adapter (10) allows circuits on the towed vehicle (12) to be powered or otherwise operated through circuits on the towing vehicle (14). The adapter (10) broadly comprises a housing (16) operable to physically connect the towed vehicle's (12) wiring to the towing vehicle's (14) wiring, a plurality of conductors (18) internal to the housing (16) each operable to electrically individually connect one of the towed vehicle's (12) circuits to one of the towing vehicle's (14) circuits, and at least one light (20) to display the status of one of the circuits. The light (20) may be colored or positioned to indicate which circuit powers the light (20).

### BACKGROUND OF THE INVENTION

1. Field of the Invention

The present invention relates to wiring adapters. More particularly, the present invention relates to a lighted wiring adapter for connecting the electrical wiring of a towed vehicle to the electrical wiring of a towing vehicle and displaying a status of the vehicles' wiring.

2. Description of Prior Art

Adapters are currently used to adapt and connect trailer wiring with that of trucks, and vise versa. These adapters allow lights and other indicators on trailers to be operated from trucks.

Unfortunately however, such adapters are often difficult to properly install and may be lost at night. This problem is especially compounded by the fact that most adapters are black, or another dark color.

Additionally, if an adapter is not properly installed, trailer lights may not operate properly. As a result, users often must spend considerable time removing and reinstalling adapters, in an effort to trouble shoot such electrical problems.

Accordingly, there is a need for an improved wiring adapter that overcomes the limitations of the prior art.

### SUMMARY OF THE INVENTION

The present invention overcomes the above-identified problems and provides a distinct advance in the art of wiring adapters. More particularly, the present invention provides a lighted wiring adapter for connecting the electrical wiring of a towed vehicle to the electrical wiring of a towing vehicle and displaying a status of the vehicles' wiring. The vehicles each include indicators, such as tail indicators, turn indicators, and/or brake indicators. Each vehicle's wiring comprises one or more circuits that operate the indicators. For example, when the towing vehicle attempts to slow down, a brake indicator circuit may be used to illuminate its brake indicators. The brake indicator circuit of the towing vehicle may also be connected through the adapter to a brake indicator circuit on the towed vehicle in order to illuminate its brake indicators. Thus, the adapter allows circuits on the towed vehicle to be powered or otherwise operated through circuits on the towing vehicle.

The adapter broadly comprises a housing operable to physically connect the towed vehicle's wiring to the towing vehicle's wiring, a plurality of conductors internal to the housing each operable to electrically individually connect one of the towed vehicle's circuits to one of the towing vehicle's circuits, and at least one light to display a status of one of the circuits.

At least a portion of the housing is substantially transparent, thereby allowing a user to see the light through the housing. The light is preferably mounted internally to the housing and visible through the transparent portion of the housing.

The light may be colored so as to emit colored illumination and is preferably colored to match the circuit that powers the light. For example, the brake indicator circuit is normally used to power red brake indicators. Thus, if the light is powered from the brake indicator circuit, it emits red illumination. Since tail indicators are also normally red, if the light is powered from a tail indicator circuit, it also emits red illumination. On the other hand, since turn indicators are normally yellow, if the light is powered from a turn indicator circuit, it emits yellow illumination.

The light may also be positioned to direct illumination toward a specific portion of the housing. For example, if the light is powered from a right brake indicator circuit, the light may by positioned adjacent a right side of the housing, thereby directing light toward the right side of the housing. Such positioning may be particularly useful when troubleshooting electrical problems, by showing which circuits are functioning. For example, the user may install the adapter on the towing vehicle and use the light to troubleshoot towing vehicle electrical problems or electrical problems between the towed vehicle and the towing vehicle. Alternatively, the light may be centrally positioned. In this case, optical conduits may be used to direct the illumination to the specific portion of the housing.

The adapter may also include an internal power storage device to power the light after the adapter has been disconnected from the towed vehicle and the towing vehicle. The power storage device is preferably a capacitor, but may also be a small battery or other power source. In any case, the power storage device is preferably charged by one of the circuits of the towing vehicle. The power storage device is particularly useful when disconnecting the adapter at night. For example, if the user drops the adapter at night, the power storage device may power the light, thereby assisting the user in locating the adapter.

### BRIEF DESCRIPTION OF THE DRAWINGS

A preferred embodiment of the present invention is described in detail below with reference to the attached drawing figures, wherein:

FIG. 1 is a perspective view of a lighted wiring adapter constructed in accordance with a preferred embodiment of the present invention and illustrated connecting a towed vehicle's wiring to a towing vehicle's wiring;

FIG. 2 is another perspective view of the adapter, wherein a housing of the adapter is substantially transparent allowing lights and conductors internal to the housing be viewed from outside the housing;

FIG. 3 is another perspective view of the adapter, wherein the housing of the adapter is substantially opaque and the lights are viewed through holes in the housing;

FIG. 4 is another perspective view of the adapter with a portion of the housing cut away to show the lights and optical conduits internal to the housing; and

FIG. 5 is an electrical schematic of certain components of the adapter.

### DETAILED DESCRIPTION OF A PREFERRED EMBODIMENT

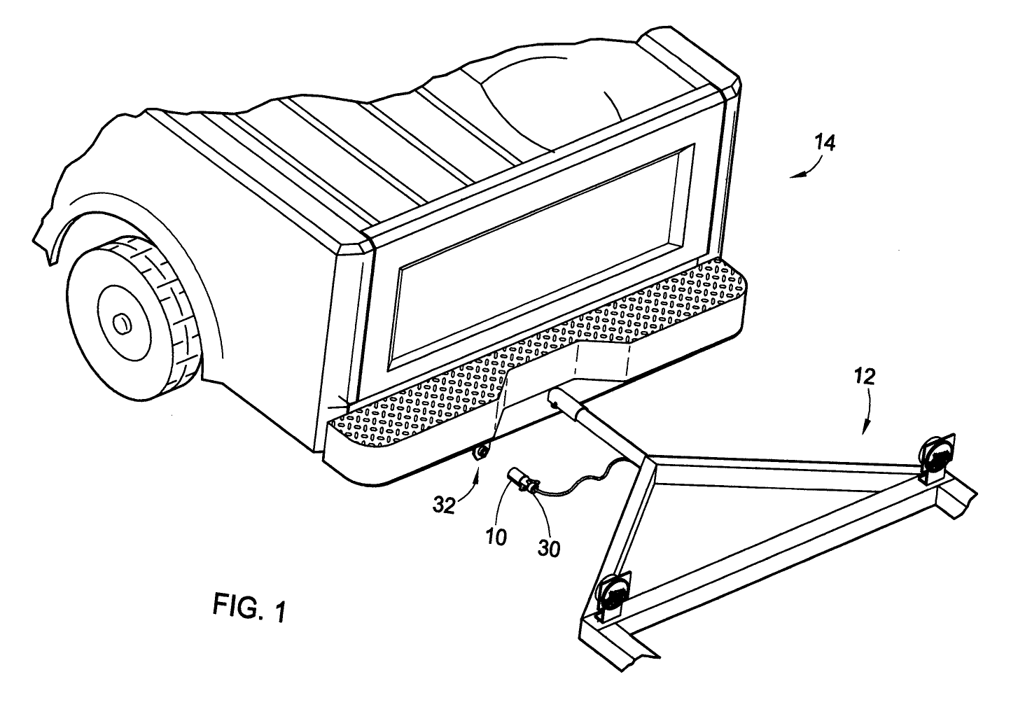

Referring to FIG. 1, a wiring adapter 10 constructed in accordance with a preferred embodiment of the present invention is illustrated connecting a towed vehicle's 12 wiring to a towing vehicle's 14 wiring in order to allow the towed vehicle's 12 wiring to be controlled through the towing vehicle's 14 wiring. The towed vehicle 12 may be a trailer, a boat, a camper or any other vehicle that can be towed behind another vehicle. For example, the towed vehicle 12 may be a conventional trailer which includes a chassis supported by one axle and two wheels. In addition, the chassis preferably includes one or more indicators, such as tail indicators, turn indicators, brake indicators, and/or running lights.

The towing vehicle 14 is typically a truck, but may be a van, a car, or some other motor vehicle. In any case, the towing vehicle preferably also has indicators, such as those described above. Each vehicle's 12,14 wiring comprises one or more circuits that operate the indicators. For example, when the towing vehicle 14 attempts to slow down, a brake indicator circuit may be used to illuminate the brake indicators on the towing vehicle 14 in order to warn others and meet licensing requirements. The brake indicator circuit of the towing vehicle 14 may also be connected through the adapter 10 to a brake indicator circuit on the towed vehicle 12 in order to illuminate brake indicators on the towed vehicle 12. Thus, the adapter 10 allows circuits on the towed vehicle 12 to be powered or otherwise operated through circuits on the towing vehicle 14.

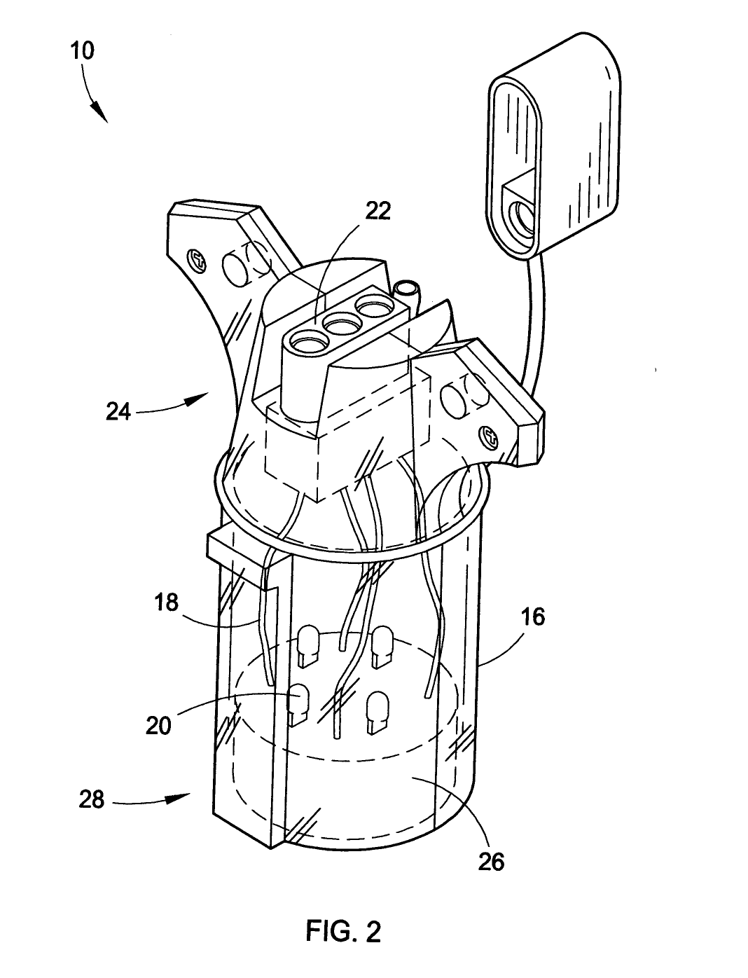

Referring also to FIG. 2, the adapter 10 broadly comprises a housing 16 operable to physically connect the towed vehicle's 12 wiring to the towing vehicle's 14 wiring, a plurality of conductors 18 internal to the housing 16 each operable to electrically individually connect one of the towed vehicle's 12 circuits to one of the towing vehicle's 14 circuits, and at least one light 20 to display a status of at least one of the circuits. The housing 16 includes a towed receptacle 22 mounted within a towed portion 24 of the housing 16 for electrically coupling the adapter 10 with the towed vehicle's 12 wiring and a towing receptacle 26 mounted within a towing portion 28 of the housing 16 for electrically coupling the adapter 10 with the towing vehicle's 14 wiring. The housing 16 is preferably substantially cylindrical, approximately one and five eighths inches in diameter, and approximately three and one half inches long. The housing 16 is preferably constructed of plastic, but may be made of any other suitable material, such as metal or a composite material.

The towed receptacle 22 is preferably generally rectangular and preferably includes a plurality of terminals that electrically individually couple the conductors 18 of the adapter 10 with each of the towed vehicle's 12 circuits. The physical arrangement of the terminals of the towed receptacle 22 and the shape of the towed end 24 of the housing 16 combine to physically mate the adapter 10 to a plug 30 which terminates the towed vehicle's 12 wiring. The towing receptacle 26 is preferably circular and preferably includes a plurality of terminals that electrically individually couple the conductors 18 of the adapter 10 with selected ones of the towing vehicle's 14 circuits. The physical arrangement of the terminals of the second receptacle 26 and the shape of the towing end 28 of the housing 16 combine to physically mate the adapter 10 to a receiver 32 which terminates the towing vehicle's 14 wiring. In this manner, the adapter 10 is operable to physically and electrically join the plug 30 with the receiver 32, thereby transmitting power and/or signals to the towed vehicle 12 from the towing vehicle 14.

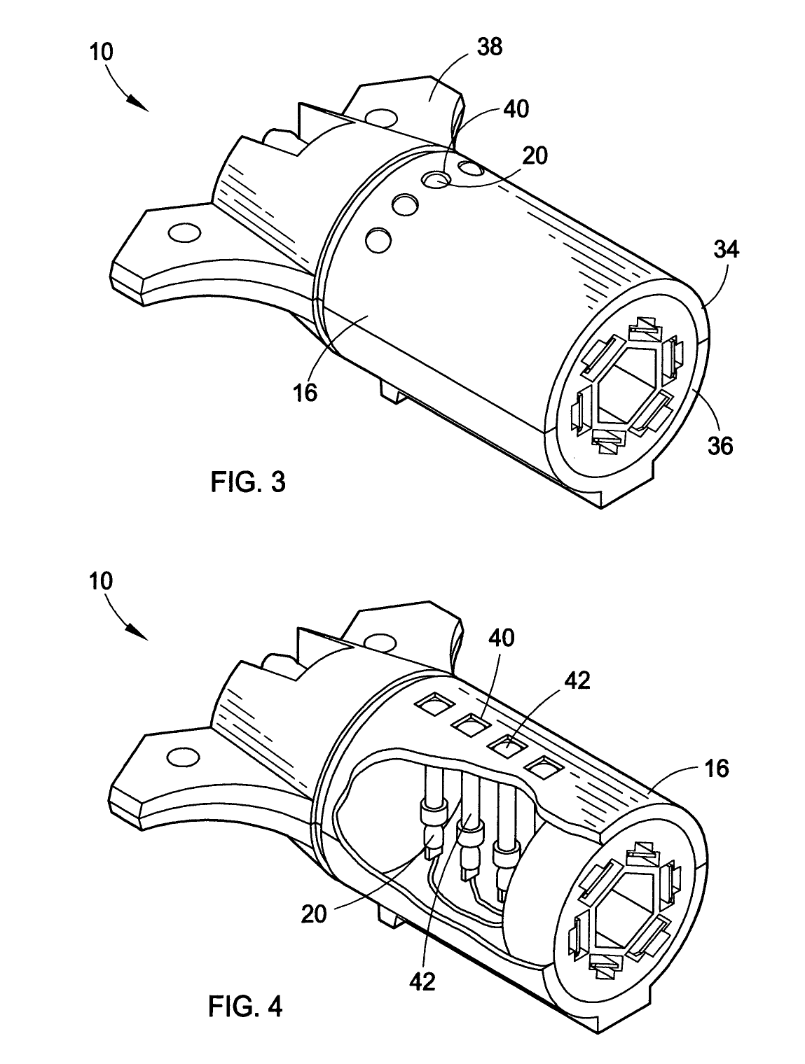

Referring also to FIG. 3, the housing 16 may be formed from a first half-shell 34 and a second half-shell 36, which mate to form the housing 16. Each half-shell 34,36 preferably includes at least one mating tab 38 with a hole through which a screw may be inserted in order to securely hold the half-shells together. The mating tabs 38 may also be used to firmly grip the housing 16, when installing or removing the adapter 10.

The conductors 18 preferably comprise at least one conductor 18 for each of the towed vehicle's 12 circuits plus one ground conductor. For example, the conductors 18 may comprise the ground conductor, a left turn conductor, a right turn conductor, and a brake indicator conductor, where the plug 30 of the towed vehicle 12 is a commonly used four-wire plug.

In order to make the towed vehicle's 12 wiring compatible with the towing vehicle's 14 wiring, the conductors 18 must be arranged in a specific electrical arrangement. The arrangement defines the manner in which the towed vehicle 12 is electrically connected to the towing vehicle 14 through the adapter 10. Thus, the arrangement is dependant upon specific characteristics of the towed vehicle 12 and the towing vehicle 14. For example, the plug 30 of the towed vehicle 12 may be the four wire plug, while the receiver 32 of the towing vehicle 14 is a six or seven wire receiver. In this case, the adapter 10 would electrically connect to only those circuits of the towing vehicle 14 that correspond to one of the towed vehicle's 12 circuits, such as the tail indicator circuit. Alternatively, the adapter 10 may include internal circuitry that monitors the towing vehicle's 14 wiring and generates appropriate signals for the towed vehicle's 12 wiring, thereby electrically isolating the vehicles 12,14 while simulating electrical connectivity.

In some cases, there is no separate tail indicator circuit. In these applications, turn indicator circuits typically provide the functionality of the tail indicator circuit or vis versa. For example, both turn indicator circuits of the towed vehicle 12 may be energized when the tail indicator circuit of the towing vehicle 14 is energized, thereby providing the functionality of the tail indicator circuit. Additionally, an appropriate one of the turn indicator circuits may be intermittently energized, thereby causing an appropriate turn indicator to flash indicating a turn and providing the functionality of the turn indicator circuit. In any case, the towed vehicle's 12 wiring preferably includes at least one brake indicator circuit and one tail indicator circuit or two turn indicator circuits.

In one embodiment of the invention, at least a portion of the housing 16 is substantially transparent, thereby allowing a user to see the light 20 through the housing 16. Alternatively, the entire housing 16 may be substantially transparent. In another embodiment, the housing 16 may be substantially opaque but includes holes 40 positioned such that the light 20 is visible therethrough, thereby allowing the user to see the light 20 through the housing 16. In this case, the holes 40 would effectively provide the substantially transparent portion of the housing 16.

Where only one light 20 is used, that light 20 is preferably powered by the tail indicator circuit. Where two lights 20 are used, a first light 20 is preferably powered by the tail indicator circuit and a second light 20 may be powered by the brake indicator circuit. The lights 20 may also be powered by other circuits, such as the turn indicator circuits, an emergency brake circuit, and/or an auxiliary power circuit.

The lights 20 are preferably mounted internally to the housing 16, but may be mounted adjacent the holes 40. The lights 20 may be clear and emit substantially white illumination or may be colored and emit colored illumination. In the latter case, the lights 20 are preferably colored to match a color normally associated with the circuit that powers the lights 20. For example, the brake indicator circuit is normally used to power red brake indicators. Thus, if one or more of the lights 20 are powered from the brake indicator circuit, those lights 20 preferably emit red illumination. Similarly, since tail indicators are also normally red, if one or more of the lights 20 are powered from the tail indicator circuit, those lights 20 preferably emit red illumination. On the other hand, since turn indicators are normally yellow, if one or more of the lights 20 are powered from the turn indicator circuits, those lights 20 preferably emit yellow illumination. However, if turn indicator circuits provide the functionality of the tail indicator circuit, as discussed above, the associated lights 20 preferably emit red illumination.

The lights 20 may also be positioned to direct illumination toward a specific portion of the housing 16. For example, where one of the lights 20 is powered from a right brake indicator circuit, that light 20 may be positioned adjacent a right side of the housing 16, thereby directing light toward the right side of the housing 16 and giving positional information. Such positional information may be particularly useful when troubleshooting electrical problems, by showing which circuits are functioning. For example, the user may install the adapter 10 on the towing vehicle 14 and use the lights 20 to troubleshoot towing vehicle 14 electrical problems. For instance, the adapter 10 may be used to determine whether a fuse or a bulb has failed, where the right brake indicator circuit of the towing vehicle 14 fails to illuminate a right brake indicator. Similarly, the adapter 10 may be used to troubleshoot electrical problems between the towed vehicle 12 and the towing vehicle 14.

Referring also to FIG. 4., the lights 20 may be centrally positioned. In this case, optical conduits 42 may be used to direct the illumination to the specific portion of the housing 16. While the optical conduits 42 may be fiber optic elements, the optical conduits 42 are preferably cylindrical clear acrylic structure that harnesses the illumination emitted from the lights 20 and directs the illumination to the specific portion of the housing 16.

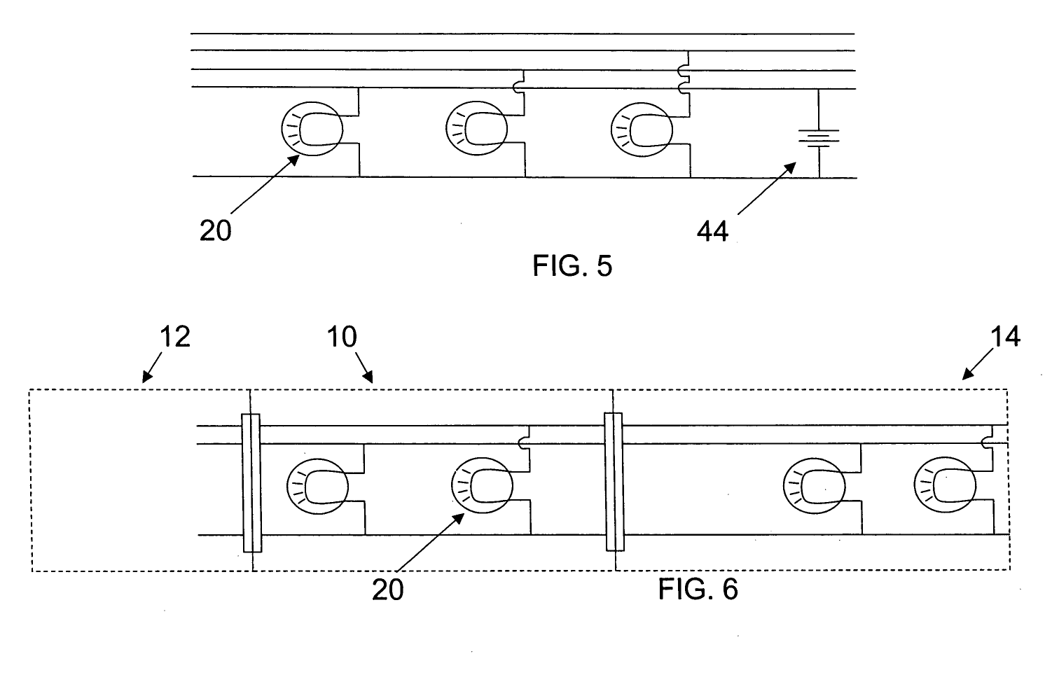

Referring also to FIG. 5, the lights 20 are preferably wired in parallel with the circuits. In this case, the lights 20 would indicate the circuit's status, when connected to the towing vehicle's 14 wiring, regardless of whether the towed vehicle's 12 wiring is functioning properly, or even connected at all. Alternatively, the lights 20 may be wired in series with the circuits. In this case, the lights 20 would indicate the circuit's status only when the associated circuit is complete and functioning properly.

The adapter 10 may also include an internal power storage device 44 to power the lights 20 after the adapter 10 has been disconnected from the towed vehicle 12 and the towing vehicle 14. The power storage device 44 is preferably a capacitor, but may be a small battery. In either case, the power storage device 44 is preferably charged by one of the circuits of the towing vehicle 14. For example, the power storage device 44 may be charged by the tail indicator circuit. The power storage device 44 is particularly useful when disconnecting the adapter 10 at night. For example, if the user drops the adapter 10 at night, the power storage device 44 may power the light 20, thereby assisting the user in locating the adapter 10.

While the present invention has been described above, it is understood that modifications may be made. For example, the towed vehicle 12 and the towing vehicle 14 may be replaced by a pushed vehicle and a pushing vehicle, respectively. As discussed above, the housing 16 and receptacles 22,26 are designed to mate with the wiring of the vehicles 12,14. Thus, the ends 24,28 of the housing 16, and the housing 16 itself, may be different that than described here, in order to properly mate with the vehicles 12,14. Additionally, the lights 20 may emit substantially white light and lenses or filters may be used to only pass colored light. Alternatively, the optical conduits 42 may be colored in order to only pass colored light. The positional information of the lights 20 may be replaced by labels, such as a right brake light label, a left brake light label, and a tail light label. Furthermore, the towed vehicle's circuits may be compatible with the towing vehicle's 14 circuits. In this case, the adapter 10 is used solely for the other functionality described above. Finally, the adapter 10 may be incorporated into the plug 30 or the receptacle 32. These and other minor modifications are within the scope of the present invention.

1. A wiring adapter for connecting a towed vehicle's wiring to a towing vehicle's wiring in order to allow the towed vehicle's wiring to be controlled through the towing vehicle's wiring, the adapter comprising:
a housing operable to physically connect the towed vehicle's wiring to the towing vehicle's wiring;
a plurality of conductors completely internal to the housing and operable to electrically connect the towed vehicle's wiring to the towing vehicle's wiring; and
at least one light internal to the housing and operable to display a status of the towing vehicle's wiring.

2. The adapter as set forth in claim 1, wherein at least a portion of the housing is substantially transparent thereby allowing the light to be observed through the housing.

3. The adapter as set forth in claim 1, wherein the entire housing is substantially transparent thereby allowing the light to be observed through the housing.

4. The adapter as set forth in claim 1, further including a power storage device operable to power the light once the adapter has been removed from the towing vehicle's wiring.

5. The adapter as set forth in claim 1, wherein the towed vehicle's wiring is otherwise incompatible with the towing vehicle's wiring.

6. The adapter as set forth in claim 1, wherein the light is powered by an auxiliary power circuit supplied by the towing vehicle.

7. The adapter as set forth in claim 1, wherein the towed vehicle's wiring includes at least one tail indicator circuit and at least one brake indicator circuit.

8. The adapter as set forth in claim 7, wherein the light is powered by the tail indicator circuit.

9. The adapter as set forth in claim 7, wherein the light is powered by the brake indicator circuit.

10. The adapter as set forth in claim 7, wherein a first light is powered by the tail indicator circuit and a second light is powered by the brake indicator circuit.

11. The adapter as set forth in claim 1, further including at least one optical conduit that directs illumination from the light to a specific portion of the housing.

12. The adapter as set forth in claim 1, wherein the light is colored to match a color normally associated with a circuit of the towed vehicle' wiring which powers the light.

13. The adapter as set forth in claim 1, wherein
a first light is powered by a left turn indicator circuit and configured to direct yellow illumination toward a left side of the housing,
a second light is powered by a brake indicator circuit and configured to emit red illumination, and
a third light is powered by a right turn indicator circuit and configured to direct yellow illumination toward a right side of the housing.

14. The adapter as set forth in claim 1, wherein the towed vehicle's wiring includes a tail indicator circuit and the light is powered by the tail indicator circuit.

15. A wiring adapter for connecting a towed vehicle's wiring to a towing vehicle's wiring in order to allow the towed vehicle's wiring to be controlled through the towing vehicle's wiring, the adapter comprising:
a housing having at least a substantially transparent portion and operable to physically connect the towed vehicle's wiring to the towing vehicle's wiring;
a towed receptacle disposed within a towed portion of the housing and having at least four connectors for physically mating with the towed vehicle's wiring:
a towing receptacle disposed within a towing portion of the housing and having at least four connectors for physically mating with the towing vehicle's wiring:
a plurality of conductors completely internal to the housing, between the receptacles, and operable to electrically individually connect a left turn indicator circuit, a right turn indicator circuit, and a tail indicator circuit of the towed vehicle's wiring to corresponding circuits of the towing vehicle's wiring; and
at least one light internal to the housing and operable to display one of the circuits' status.

16. The adapter as set forth in claim 15, further including a power storage device operable to power the light once the adapter has been removed from the towing vehicle's wiring.

17. The adapter as set forth in claim 15, wherein the light is powered by the tail indicator circuit.

18. The adapter as set forth in claim 15, wherein the light is colored to match a color normally associated with a selected one of the circuits with the selected circuit powering the light.

19. The adapter as set forth in claim 15, wherein
a first light is powered by the left turn indicator circuit and configured to direct yellow illumination toward a left side of the housing,
a second light is powered by the right turn indicator circuit and configured to direct yellow illumination toward a right side of the housing, and
a third light is powered by the tail indicator circuit and configured to emit red illumination.

20. A wiring adapter for connecting a towed vehicle's wiring to a towing vehicle's wiring in order to allow the towed vehicle's wiring to be controlled through the towing vehicle's wiring, the adapter comprising:
a housing operable to physically connect the towed vehicle's wiring to the towing vehicle's wiring and at least a portion of which is substantially transparent;
a towed receptacle disposed within a towed portion of the housing and having at least four connectors for physically mating with the towed vehicle's wiring:
a towing receptacle disposed within a towing portion of the housing and having at least four connectors for physically mating with the towing vehicle's wiring;
a plurality of conductors completely internal to the housing, between the receptacles, and operable to electrically individually connect a left turn indicator circuit, a right turn indicator circuit, and a tail indicator circuit of the towed vehicle's wiring to corresponding circuits of the towing vehicle's wiring; and
a first light powered by the left turn indicator circuit and configured to direct a first illumination toward a left side of the housing;
a second light powered by the right turn indicator circuit and configured to direct a second illumination toward a right side of the housing;
a third light powered by the tail indicator circuit and configured to emit a third illumination; and
wherein the first, second, and third illumination are individually selected from the group consisting of red and yellow illumination.

21. The adapter as set forth in claim 20, further including a power storage device operable to power at least one of the lights once the adapter has been removed from the towing vehicle's wiring.

22. A wiring adapter for connecting a towed vehicle's wiring to a towing vehicle's wiring in order to allow the towed vehicle's wiring to be controlled through the towing vehicle's wiring, the adapter comprising:
a housing operable to physically connect the towed vehicle's wiring to the towing vehicle's wiring, wherein at least a portion of the housing is substantially transparent;
a towed receptacle disposed adjacent the housing and having at least four connectors for physically mating with the towed vehicle's wiring;
a towing receptacle disposed adjacent the housing and having at least four connectors for physically mating with the towing vehicle's wiring;
at least four conductors internal to the housing and operable to electrically individually connect a left turn indicator circuit, a right turn indicator circuit, and a tail indicator circuit of the towed vehicle's wiring to corresponding circuits of the towing vehicle's wiring;
a first light powered by the left turn indicator circuit;
a first optical conduit configured to direct a first illumination from the first light toward a left side of the housing;
a second light powered by the right turn indicator circuit;
a second optical conduit configured to direct a second illumination from the second light toward a right side of the housing;
a third light powered by the tail indicator circuit;
a third optical conduit configured to direct a third illumination from the third light;
wherein the first, second, and third illumination are individually selected from the group consisting of red and yellow illumination; and
a power storage device disposed within the housing and operable to power at least one of the lights after the adapter has been removed from the towing vehicle's wiring.

23. A wiring adapter for connecting a towed vehicle's wiring to a towing vehicle's wiring in order to allow the towed vehicle's wiring to be controlled through the towing vehicle's wiring, the adapter comprising:
a housing operable to physically connect the towed vehicle's wiring to the towing vehicle's wiring, wherein at least a portion of the housing is substantially transparent;
a towed receptacle disposed adjacent the housing and having at least four connectors for physically mating with the towed vehicle's wiring;
a towing receptacle disposed adjacent the housing and having at least four connectors for physically mating with the towing vehicle's wiring;
at least four conductors internal to the housing and operable to electrically individually connect a left turn indicator circuit, a right turn indicator circuit, and a tail indicator circuit of the towed vehicle's wiring to corresponding circuits of the towing vehicle's wiring;
a light powered by one of the circuits;
an optical conduit configured to direct illumination from the light toward a side of the housing;
wherein the illumination is selected from the group consisting of red and yellow illumination; and
a power storage device disposed within the housing and operable to power at least one of the lights after the adapter has been removed from the towing vehicle's wiring.
